(19) United States
(12) Patent Application Publication
(10) Pub. No.: US 2012/0138576 A1
(43) Pub. Date: Jun. 7, 2012

(54) COMPOUND ELECTRICAL DISCHARGE MACHINING APPARATUS AND SMALL-HOLE ELECTRICAL DISCHARGE MACHINING MODULE THEREOF

(76) Inventor: Yin Chuang, (US)

(21) Appl. No.: 12/982,511

(22) Filed: Dec. 30, 2010

(30) Foreign Application Priority Data
Dec. 3, 2010 (TW) 099142104

(51) Int. Cl. B23H 1/08

(52) U.S. Cl. 219/69.12; 219/69.11

(57) ABSTRACT

The present invention relates to a compound electrical discharge machining (EDM) apparatus, which combines a small-hole EDM module and a wire-cut EDM apparatus and hence having the functions of small-hole and wire-cut EDM simultaneously. Thereby, in the compound EDM apparatus, a workpiece can be first processed by the small-hole EDM and subsequently by the wire-cut EDM without repositioning. Accordingly, automatic processing can be achieved. The inability of full automation in wire-cut EDM machines owing to lack of small-hole EDM functionality is improved.

### FIELD OF THE INVENTION

The present invention relates generally to a machining apparatus, and particularly to a compound electrical discharge machining apparatus with small-hole and wire-cut electrical discharge machining capabilities and to a small-hole electrical discharge machining module thereof.

### BACKGROUND OF THE INVENTION

The electrical discharge machining (EDM) is a non-traditional machining method widely adopted by the industry at present. The research of EDM was first started in the US and the late USSR and then spread to other countries worldwide. In the US, scientists have observed and researched the melting-corrosion phenomenon as early as 1768. In 1878, electrical fountain pens, which use discharge for writing, are developed. In 1943, practical EDMs are commercialized in the US. At first, the AC power is adopted. Afterwards, it is found that by using DC power, the machining speed could be raised. At the same time, EDM machines with servomechanisms were developed. In 1950, vibrational electric-arc discharge machining machines, which are the predecessors of modern EDM machines, are developed.

On the other hand, in the late USSR, scientists researched the discharging properties in working fluids in 1941. And in 1943, they announced spark erosion machining, which used capacitors and resistors to form the prototypical EDM machine. The electrical circuit is named the Lazarenko RC circuit. In addition, Europe didn't start researches on EDM until 1947. In 1953, auto-controlled machining machines are developed. In 1954, the Agie Company in Switzerland announced the first high-precision EDM machine. In Japan, the earliest EDM machine was developed in 1948, and the machining method was officially named EDM. Since then, Japan delved aggressively into the research of the EDM technology.

Early EDM machines had the drawbacks of low machining speed and high electrode consumption, and thus limiting their applications. However, after improvements, EDM machines have not only raised the machining speed but also lowered consumption of electrodes, leading to their increasingly wider applications. Thanks to technological advancements and accumulation of experiences, servo control systems are gradually developed and applied to EDM machines, and hence making the functions of EDM machines more complete with more precision. Thereby, EDM has become an indispensable machining method in industry.

Presently, EDM machines include small-hole, wire-cut, and engraving EDM machines. If the wire-cut EDM is to be performed on a workpiece, a through hole has to be opened from the workpiece. Then thread the wire electrode through the through hole and start the wire-cut EDM. Nevertheless, because wire-cut EDM machines do not have the function of opening a through hole in a workpiece, the opening process has to be done in other machines, which are generally small-hole EDM machines. After a through hole is opened from the workpiece by the small-hole EDM machine, the workpiece is moved to the wire-cut EDM machine and positioned. The wire electrode of the wire-cut EDM machine is threaded through the through hole in the workpiece for performing wire-cut EDM. However, the threading capabilities of current wire-cut EDM machines are uneven. When machining areas are small, plenty, or dense, automatic machining is not easy to implement, leading to limited processing speed, raised costs in labor, and weak competitiveness. Besides, there are various kinds of small-hole EDM machines. Unfortunately, most of them are complicated in structure and have bad precision in processing.

In order to solve the problem described above, the present invention provides a compound EDM apparatus and a small-hole EDM module thereof. The compound EDM apparatus have both the small-hole EDM and wire-cut EDM capabilities. Thereby, the inability of full automation in wire-cut EDM machines according to the prior art owing to lack of small-hole EDM functionality is improved. The structure of a small-hole EDM module is simple, and thereby its installation cost is low. In addition, the small-hole EDM module can be assembled to a wire-cut EDM apparatus and becomes a compound EDM apparatus.

### SUMMARY

An objective of the present invention is to provide a compound EDM apparatus, which combines the small-hole EDM and wire-cut EDM. Thereby, in the compound EDM apparatus, a workpiece can be first processed by the small-hole EDM and subsequently by the wire-cut EDM without repositioning. Accordingly, the inability of full automation in wire-cut EDM machines owing to the need of manual threading is improved.

Another objective of the present invention is to provide a small-hole EDM module, which is simple in structure as well as in operation, and hence reducing installation costs and enhancing convenience in operations.

In order to achieve the objectives described above, the present invention provides a compound EDM apparatus, which comprises a wire-supplying module, a guiding tube, a transmission module, a top wire guide, a processing platform, a power module, a bottom wire guide, and a wire-retrieving module. The wire-supplying module is used for supplying a wire electrode. The guiding tube is located below the wire-supplying module for the wire electrode to pass through and be guided. The transmission module is located below the guiding tube for transmitting the wire electrode passing through the guiding tube. The top wire guide is located below the transmission module and corresponds to the guiding tube. The transmission module transmits the wire electrode to thread through the top wire guide. The processing platform is located below the top wire guide and carries a workpiece. Both electrodes of the power module are connected to the wire electrode and the workpiece, respectively. The power module supplies power to the wire electrode and the workpiece for performing EDM and forming a through hole through the workpiece. Besides, the wire electrode threads through the workpiece. The bottom wire guide is located below the processing platform and corresponds to the top wire guide. The transmission module carries the wire electrode threading through the workpiece to pass through the bottom wire guide. The wire-retrieving module is disposed below the bottom wire guide, and is used for retrieving and rolling up the wire electrode threading through the bottom wire guide. When the wire electrode threads through the hole through the workpiece and the bottom wire guide, the power module further supplies power to the wire electrode and the workpiece for performing wire-cut EDM.

The present invention further provides a small-hole EDM module, which comprises a guiding tube, a transmission module, a wire guide, and a power module. The guiding tube is used for threading the wire electrode therethrough and guiding the wire electrode. The transmission module is located below the guiding tube for transmitting the wire electrode passing through the guiding tube. The wire guide is located below the transmission module and corresponds to the guiding tube. The transmission module transmits the wire electrode to thread through the top wire guide. Both electrodes of the power module are connected to the wire electrode and the workpiece, respectively, where the workpiece is located below the wire guide. The power module supplies power to the wire electrode and the workpiece for performing EDM and forming a hole through the workpiece.

### BRIEF DESCRIPTION OF THE DRAWINGS

FIG. 1 shows a structural diagram according to a preferred embodiment of the present invention;

FIG. 2A shows an operational schematic diagram of performing small-hole EDM according to a preferred embodiment of the present invention;

FIG. 2B shows another operational schematic diagram of performing small-hole EDM according to a preferred embodiment of the present invention;

FIG. 3 shows a structural diagram according to a second preferred embodiment of the present invention;

FIG. 4 shows a structural diagram according to a third preferred embodiment of the present invention;

FIG. 5 shows an operational schematic diagram of performing small-hole and wire-cut EDM according to the third preferred embodiment of the present invention; and

FIG. 6 shows an operational schematic diagram according to a fourth preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

Generally speaking, in order to form a die cavity in a die block (or a workpiece) and perform wire-cut EDM to the die block, it is necessary to use a small-hole EDM machine first to form a through hole in the die block. Then place the die block to a wire-cut EDM machine for performing wire-cut EDM to the die block. Before wire-cut EDM, it is required to thread a wire electrode to be used during processing through the die block. When the die cavities are small or dense, it is difficult for a wire-cut EDM machine according to the prior art to thread holes automatically. Accordingly, the die block has to be positioned manually before the wire electrode can be threaded through the hole of the die block and processed by wire-cut EDM. In this way, full automation cannot be achieved, let alone extra labors have to be invested. In addition, the structure of current small-hole EDM machines is complex and their threading precision is poor. Thereby, the present invention provides a compound EDM apparatus and a small-hole EDM module. The small-hole EDM module can be assembled to a wire-cut EDM apparatus and becomes a compound EDM apparatus, which owns small-hole EDM and wire-cut EDM functions simultaneously. Consequently, the purpose of full automation can be achieved.

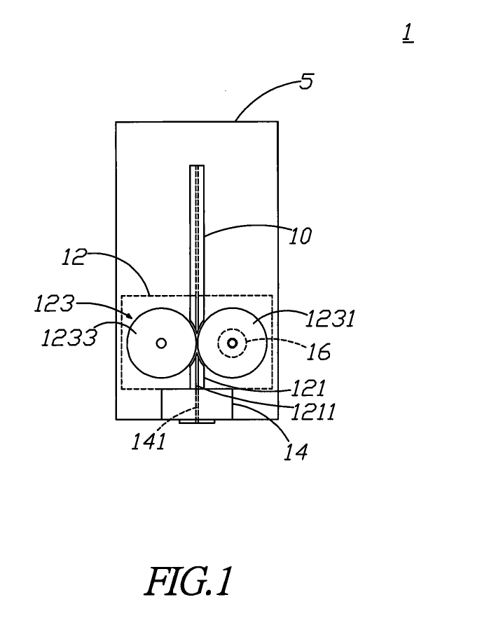

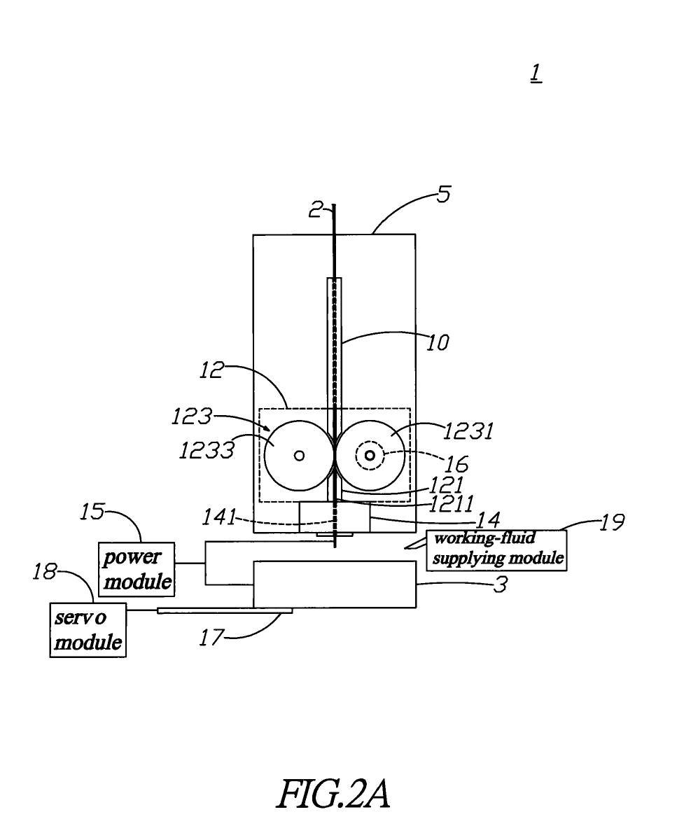

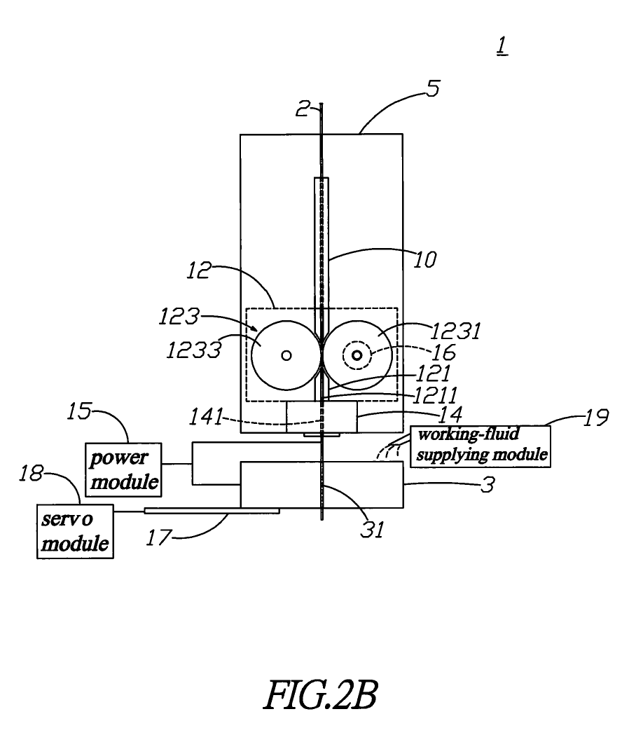

FIG. 1 shows a structural diagram according to a preferred embodiment of the present invention; FIGS. 2A and 2B show operational schematic diagrams of performing small-hole EDM according to a preferred embodiment of the present invention. As shown in the figures, the present embodiment is a small-hole EDM module 1, which comprises a guiding tube 10, a transmission module 12, a wire guide 14, and a power module 15. The small-hole EDM module 1 further comprises a base 5 for the guiding tube 10, the transmission module 12, and the wire guide 14 to be fixed on. The guiding tube 10 is mainly used to be passed by a wire electrode 2 (refer to FIG. 2A) for guiding the wire electrode 2. Hence, it prevents the situation that the displacement of the wire electrode 2 is shifted from a predetermined position due to insufficiency in vertical precision. The transmission module 12 is located below the guiding tube 10 for receiving and transmitting the wire electrode 2 threading through the guiding tube 10. The wire guide 14 is located below the transmission module 12 and has a guiding channel 141. The guiding channel 141 corresponds to and is in alignment with the guiding tube 10. The transmission module 12 clips and transmits the wire electrode 2 threading through the guiding tube 10 to pass through the guiding channel 141. The guiding channel 141 is used for guiding the wire electrode 2 to thread through the wire guide 14. Thereby. The wire electrode 2 can be guided to the predetermined position with certainty.

Both electrodes of the power module 15 are connected to the wire electrode 2 and a workpiece 3, respectively (refer to FIG. 2A). Thereby, while performing small-hole EDM, the power module 15 can supply power to the wire electrode 2 and the workpiece 3 and thus forming a hole 31 in the workpiece 3 (refer to FIG. 2B).

The transmission module 12 includes at least a wheel set 123, which comprises a first transmission wheel 1231 and a second transmission wheel 1233. The first transmission wheel 1231 and the second transmission wheel 1233 are located below the guiding tube 10 and correspond to both sides of the guiding tube 10. The second transmission wheel 1233 is parallel to the first transmission wheel 1231. The first transmission wheel 1231 is the driving wheel; the second transmission wheel 1233 is the driven wheel. The first transmission wheel 1233 further connects to a driving module 16. An embodiment of the driving module 16 is a servomotor. The driving module 16 drives the first transmission wheel 1231 to rotate. The first transmission wheel 1231 drives the second transmission wheel 1233 to rotate. An embodiment of the second transmission wheel 1233 is a pressure wheel. The second transmission wheel 1233 is pressed on the side of the first transmission wheel 1231.

When the wire electrode 2 threading through the guiding tube 10 is transmitted to the wheel set 123, the wire electrode 2 is located between the first and the second transmission wheels 1231, 1233. The second transmission wheel 1233 applies pressure on the first transmission wheel 1231, and thereby the wire electrode 2 is clipped and held vertically. Then the first and the second transmission wheels 1231, 1233 rotate to drive the wire electrode 2 to move downwards. Thereby, the wire electrode 2 is transmitted to the guiding channel 141 of the wire guide 14 with precision.

The transmission module 12 further includes a guiding base 121 used for ensuring that the wire electrode 2 moves linearly. The guiding base 12 is disposed between the wheel set 123 and the wire guide 14 and has a guiding channel 1211 communicating with the guiding channel 141 of the wire guide 14. Besides, the guiding channel 1211 is in line with the guiding tube 10. The first and the second transmission wheels 1231, 1233 of the wheel set 123 clip and drive the wire electrode 2 to pass through the guiding channel 1211 of the guiding base 121. Hence, the transmission module 12 transmits the wire electrode 2 to the guiding channel 141 of the wire guide 14. In this way, the wire electrode 2 can be transmitted to the predetermined position precisely for performing small-hole EDM.

Refer again to FIGS. 2A and 2B. When the small-hole EDM module 1 according to the present embodiment performs small-hole EDM to the workpiece 3, the workpiece 3 is fixed on a processing platform 17 and thus located below the wire guide 14. The processing platform 17 is controlled by a servo module 18 and moves to the predetermined position. The wire electrode 2 is guided to the transmission module 12 via the guiding tube 10, and is transmitted to the wire guide 14 via the transmission module 12 for guiding the wire electrode 2 to the predetermined position via the wire guide 14. While performing EDM, both electrodes of the power module 15 are connected to the wire electrode 2 and the workpiece 3, respectively, for supplying power to the wire electrode 2 and the workpiece 3. Electrical discharge effect will take place between the wire electrode 2 and the workpiece 3 and forming cavities on the workpiece 3. The wheel set 123 of the transmission module 12 controls the wire electrode 2 to move forwards or backwards and hence performing EDM on the workpiece 3 at the same location. Thereby, the hole 31 (refer to FIG. 2B) can be formed in the workpiece 3. The hole 31 can be a penetrating or a non-penetrating hole.

In addition, the small-hole EDM module 1 further includes a working-fluid supplying module 19. When the wire electrode 2 performs EDM on the workpiece 3, a dielectric fluid (working fluid) for cooling the wire electrode 2 and the workpiece 3 is further added by the working-fluid supplying module 19. It can also recover insulation between the wire electrode 2 and the workpiece 3. After the hole 31 is formed in the workpiece 3, the wheel set 123 of the transmission module 12 drives the wire electrode 2 to thread through the hole 31 in the workpiece 3. The material of the wire electrode 2 according to the present embodiment can be copper. However, the material of the wire electrode 2 is not limited to copper, other conductive materials can be used as the wire electrode 2. The small-hole EDM module 1 can be disposed in a wire-cut EDM apparatus and becomes a compound EDM apparatus, which owns the functions of small-hole and wire-cut EDM simultaneously.

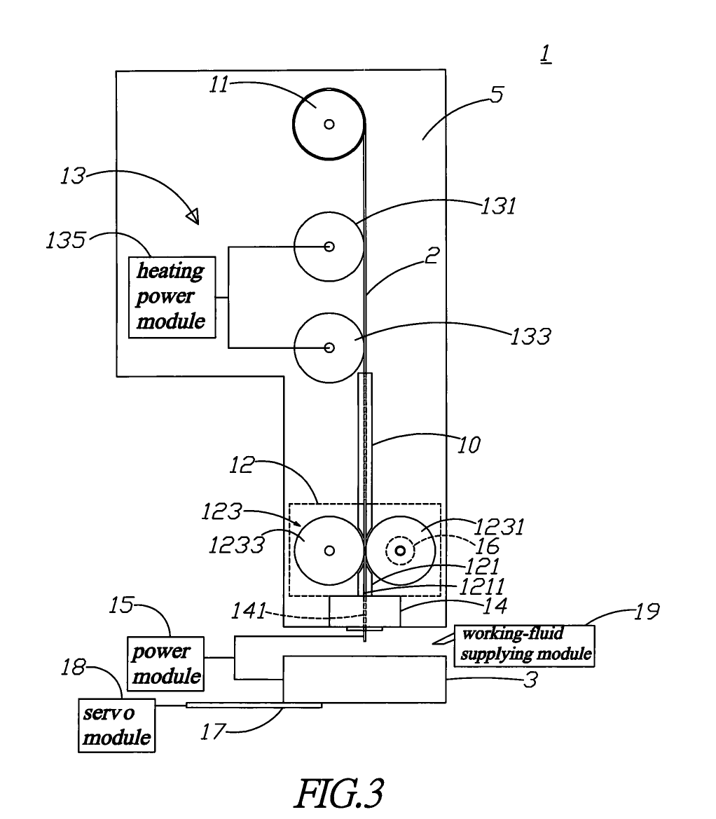

FIG. 3 shows a structural diagram according to another preferred embodiment of the present invention. As shown in the figure, the difference between the present embodiment and the one in FIG. 1 is that the small-hole EDM module 1 according to the present embodiment further includes a reel module 11 and a heating module 13, both disposed on the base 5 and located above the guiding tube 10. The reel module 11 is a wheel set used for reeling and supplying the wire electrode 2.

The wire electrode 2 is reeled on the reel module 11. The reel module 11 rotates and supplies the wire electrode 2 to the guiding tube 10. The heating module 13 is disposed between the reel module 11 and the guiding tube 10 and located on one side of the wire electrode 2. The heating module 13 includes at least a heating element and a heating power module 135. According to the present embodiment, the heating module includes two heating elements, namely, a first heating element 131 and a second heating element 133. The first heating element 131 is located above the second heating element 133. The heating power module 135 connects and supplies power to the first and the second heating elements 131, 133 for them.

When the wire electrode 2 supplied by the reel module 11 passes through the guiding tube 10 and is clipped by the wheel set 123 of the transmission module 12, the wire electrode 2 will contact the first and the second heating elements 131, 133. The first and the second heating elements 131, 133 will then heat the wire electrode 2 for a period to soften the wire electrode 2. At this moment, the wheel set 123 clips the other end of the wire electrode 2. By reversely rotating the reel module 11, the wire electrode 2 can be retrieved and straightened. Finally, after the wire electrode 2 is cooled and straightened, the driving module 16 drives the wheel set 123 of the transmission module 12 to rotate for clipping and moving the straightened wire electrode 2 for performing small-hole EDM. The front unstraightened segment of the wire electrode 2 will be cut before small-hole EDM. The heating module 13 described above can also be disposed between the guiding tube 10 and the transmission module 12. Its location is not limited.

According to the present embodiment, the heating module 13 is mainly used for avoiding influences on the precision (such as straightness and perpendicularity) of forming the hole 31 in the workpiece 3 caused by insufficiency in straightness of the wire electrode 2 during small-hole EDM. The heating module 13 heats the wire electrode 2 to a semi-softened state. Then the reel module 11 works in coordination with the transmission module 12 to straightened the wire electrode 2 Afterwards, the wire electrode 2 is placed unmoved for cooling. One cooling method can be air cooling by ambient air for hardening and straightening the wire electrode 2. Consequently, the wire electrode 2 can be straightened, effectively preventing deviation problem, and thereby machining precision, owing to inaccuracy in straightness of the wire electrode 2.

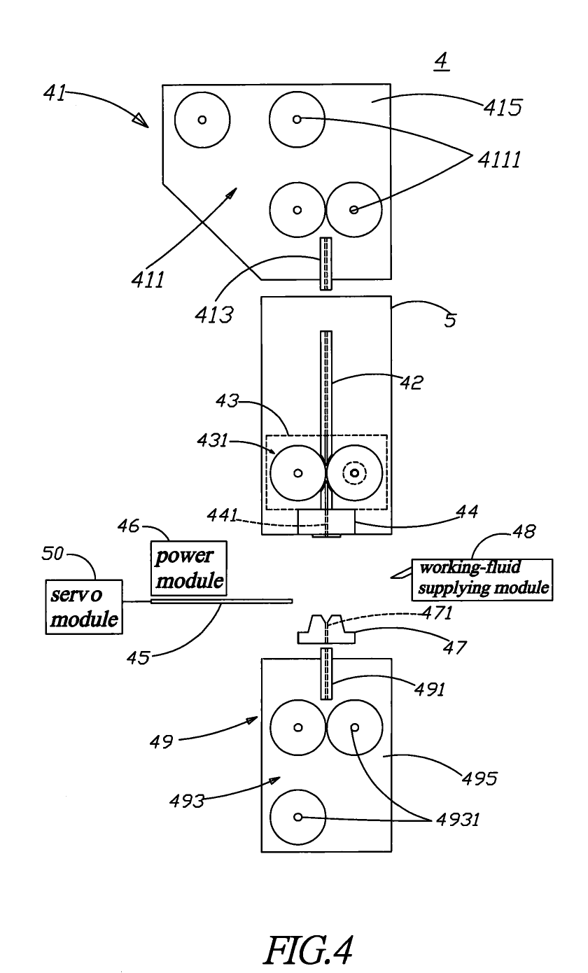

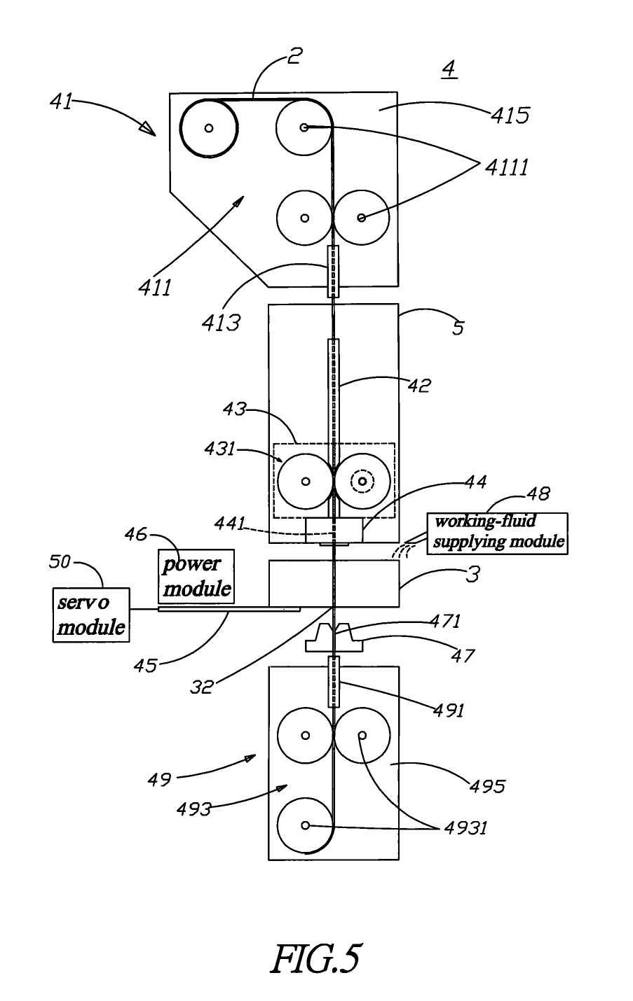

FIG. 4 and FIG. 5 show a structural diagram and an operational schematic diagram of performing EDM according to a third preferred embodiment of the present invention. As shown in the figures, the present embodiment provides a compound EDM apparatus 4, which comprises a wire-supplying module 41, a guiding tube 42, a transmission module 43, a top wire guide 44, a processing platform 45, a power module 46, a bottom wire guide 47, and a wire-retrieving module 49. The wire-supplying module 41 reeled with the wire electrode 2 for supplying the wire electrode 2, and includes a wheel set 411, a guiding channel 413, and a base 415. The wheel set 411 and the guiding channel 413 are disposed on the base 415. The guiding channel 413 corresponds to the guiding tube 42. The wheel set includes a plurality of wheels 4111 and drives the wire electrode 2 to enter the guiding channel 413. The wire electrode 2 passes through the guiding channel 413 and moves to the guiding tube 42. The guiding channel 413 can prevent the wire electrode 2 from deviation and thus avoiding difficulty in entering the guiding tube 42.

The guiding tube 42, the transmission module 43, and the top wire guide 44 are the guiding tube 10, the transmission module 12, and the wire guide 14 of the small-hole EDM module according to the embodiment in FIG. 1. Please refer to the relevant description in FIG. 1 for their details. The guiding tube 42, the transmission module 43, and the top wire guide 44 are fixed on the base 5. The guiding tube 42 is located below the wire-supplying module 41, and corresponds to and is line with the guiding channel 413 of the wire-supplying module 41. The wheel set 411 of the wire-supplying module 41 drives the wire electrode 2 to pass through the guiding channel 413 and the guiding tube 42. The guiding tube 42 then guides the wire electrode 2 to the transmission module 43.

The transmission module 43 is located below the guiding tube 42, and mainly includes a wheel set 431, which is identical to the wheel set 123 according to the embodiment in FIG. 1. The wheel set 431 clips and drives the wire electrode 2 to the top wire guide 44. The top wire guide 44 is located below the transmission module 43 and corresponds to the guiding tube 42. The top wire guide 44 has a guiding channel 441. The transmission module 42 transmits the wire electrode 2 to the guiding channel 441 of the top wire guide 44. The wire electrode 2 passes through the guiding channel 441 of the top wire guide 44. The guiding channel 441 then guides the wire electrode 2 to thread though the top wire guide 44.

The processing platform 45 is located below the top wire guide 44 and used for carrying and positioning the workpiece 3. The processing platform 45 is controlled by a servo module 50. Referring to FIG. 5, while machining a die cavity at the center of the workpiece 3, it is required to form a through hole 32. Then the wire electrode 2 threads though the through hole 32 in the workpiece 3 for subsequent wire-cut EDM on the through hole 32.

When the compound EDM apparatus 4 is to perform small-hole EDM on the workpiece 3, both electrode of the power module 46 are connected to the wire electrode 2 and the workpiece 3 for supplying power to them and facilitating the wire electrode 2 to perform small-hole EDM on the workpiece 3 and forming the through hole in the workpiece 3. The compound EDM apparatus 4 further comprises a working-fluid supplying module 48. When the wire electrode 2 performs EDM on the workpiece 3, the working-fluid supplying module 48 supplies a dielectric fluid to the wire electrode 2 and the workpiece 3. The dielectric fluid can cool the wire electrode 2 and the workpiece 3. It also can recover insulation between the wire electrode 2 and the workpiece 3.

After the through hole 32 is formed in the workpiece 3 and the wire electrode 2 threads through the through hole 32 in workpiece 3, the wire electrode 2 is driven to the bottom wire guide 47 via the wheel set 411 of the wire-supplying module 41 and the wheel set 431 of the transmission module 43. The bottom wire guide 47 is located below the processing platform 45 and corresponds to the top wire guide 44. The bottom wire guide 47 has a guiding channel 471 corresponding to and in line with the guiding channel 441 of the top wire guide 44. The wire electrode 2 passes through the guiding channel 471, which guides the wire electrode 2 to thread through the bottom wire guide 47. The guiding channel 471 is mainly used for preventing deviation of the wire electrode 2. When the wire electrode 2 threads through the bottom wire guide 47, the wheel set 411 of the wire-supplying module 41 and the wheel set 431 of the transmission module 43 continue to drive the wire electrode 2 to the wire-retrieving module 49.

The wire-retrieving module 49 is located below the bottom wire guide 47 and used for retrieving the wire electrode 2 threading through the bottom wire guide 47. The wire-retrieving module 49 has a guiding channel 491, a wheel set 493, and a base 495. The guiding channel 491 and the wheel set 493 are fixed on a fixing base 495. The wire electrode 2 threading through the bottom wire guide 47 passes through the guiding channel 491 to the wheel set 493. The wheel set 493 includes a plurality of wheels 4931 and drives the wire electrode 2 for retrieving. After one end of the wire electrode 2 is fixed on the wire-retrieving module 49 and the wire electrode 2 is retrieved, the power module 46 supplies power to the wire electrode 2 and the workpiece 3 so that the wire electrode 2 can perform wire-cut EDM on the workpiece 3.

It is known from above that after the compound EDM apparatus 4 according to the present invention finishes small-hole EDM and wire-cut EDM is to be performed subsequently, it is not necessary to move and reposition the workpiece 3. Besides, no manual threading is required either. Thereby, the positioning time is shortened and EDM efficiency is enhanced.

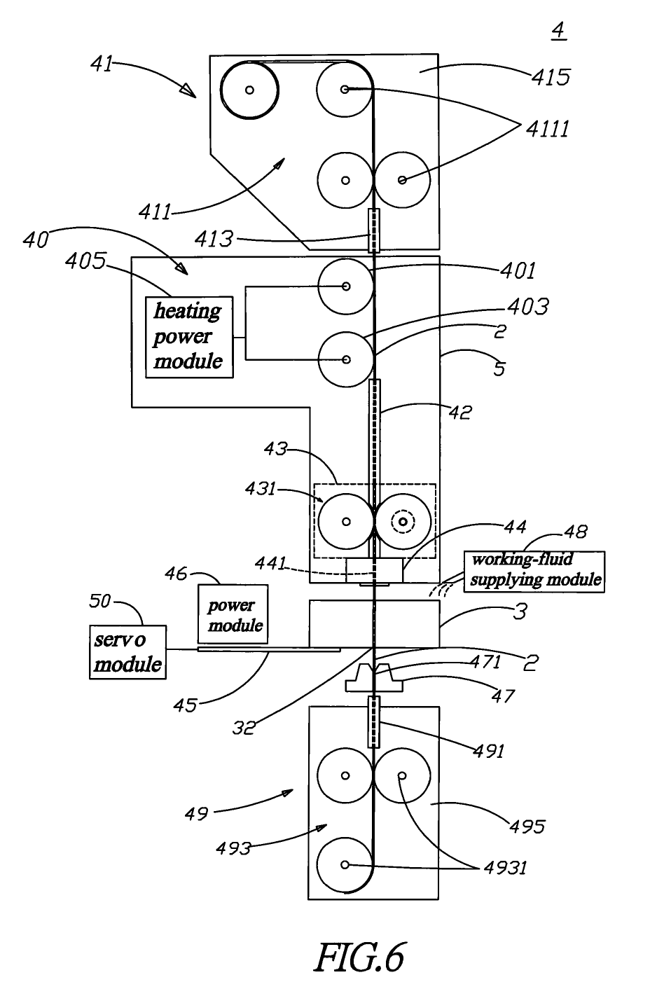

FIG. 6 shows an operational schematic diagram according to a fourth preferred embodiment of the present invention. The heating module 12 disclosed in FIG. 3 can be combined to the compound EDM apparatus 4 disclosed in FIG. 4. The compound EDM apparatus 4 further comprises a heating module 40. The heating module 40 is disposed between the wire-supplying module 41 and the guiding tube 42. The heating module 40 includes a first heating element 401, a second heating element 403, and a heating power module 405. The first and the second heating elements 401, 403 are located on the path via which the wire electrode 2 enters the guiding tube 42. The second heating element 403 is located below the first heating element 401. The heating power module 405 connects to the first and the second heating elements 401, 403. While straightening the wire electrode 2, the heating power module 405 supplies power to the first and the second heating elements 401, 403 for heating. The first and the second heating elements 401, 403 produce heat to heat, and thus soften, the wire electrode 2.

Next, the wheel set 431 of the transmission module 43 clips the wire electrode 2. The wire-supplying module 41 rotates reversely and tightens the wire electrode 2 for straightening it. Finally, after the semi-softened wire electrode 2 is cooled and straightened, it is transmitted to the top wire guide by the transmission module 43 for subsequent small-hole and wire-cut EDM.

It is known from above that the compound EDM apparatus according to the present invention combines the small-hole EDM module and a wire-cut EDM apparatus, enabling the compound EDM apparatus to have both the functions of the small-hole EDM and wire-cut EDM. Thereby, a workpiece can finish small-hole EDM and wire-cut EDM in the compound EDM apparatus. During wire-cut EDM, no repositioning of the workpiece or manual threading is needed. Consequently, the processing time can be saved and the processing efficiency can be enhanced.

Moreover, because the wire-cut apparatus does not have the function of small-hole EDM, a workpiece has to be small-hole-EDM processed in a small-hole EDM apparatus first then moved to a wire-cut EDM apparatus for wire-cut EDM. In this way, repositioning is indispensable for threading the wire electrode through the through hole of the workpiece. Nevertheless, manual operations are required to move the workpiece to the wire-cut EDM apparatus according to the prior art, which means full automation cannot be achieved and thus limiting processing efficiency. The compound EDM apparatus according to the present invention has completely improved the automation problem occurred in the wire-cut EDM apparatus according to the prior art. Thereby, processing efficiency and precision can be enhanced effectively.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A compound electrical discharge machining apparatus, comprising:
a wire-supplying module, supplying a wire electrode;
a guiding tube, located below said wire-supplying module, and passed by and guiding said wire electrode;
a transmission module, located below said guiding tube, and transmitting said wire electrode passing through said guiding tube;
a top wire guide, located below said transmission module, corresponding to said guiding tube, and said transmission module transmitting said wire electrode to thread through said top wire guide;
a processing platform, located below said top wire guide, and carrying a workpiece;
a power module, connecting to said wire electrode and said workpiece, supplying power to said wire electrode and said workpiece for performing small-hole electrical discharge machining and forming a through hole in said workpiece, and said wire electrode threading through said workpiece;
a bottom wire guide, located below said processing platform, corresponding to said top wire guide, and said transmission module driving said wire electrode threading through said workpiece to thread through said bottom wire guide; and
a wire-retrieving module, disposed below said bottom wire guide, and retrieving said wire electrode threading through said bottom wire guide;
where said electrode threads through said through hole in said workpiece and said bottom wire guide, and said power module supplies power to said wire electrode and said workpiece for performing wire-cut electrical discharge machining.

2. The compound electrical discharge machining apparatus of claim 1, and further comprising a heating module, heating said wire electrode, said transmission module clipping and fixing one end of said wire electrode, and said wire-supplying module retrieving said wire electrode for straightening said wire electrode.

3. The compound electrical discharge machining apparatus of claim 2, wherein said heating module further comprises:
at least a heating element, contacting said wire electrode; and
a heating power module, coupled to said heating element, and supplying power to said heating element for heating said wire electrode.

4. The compound electrical discharge machining apparatus of claim 1, wherein said transmission module includes a wheel set, comprising:
a first transmission wheel, located below said guiding tube; and
a second transmission wheel, located below said guiding tube and corresponding to said first transmission wheel, said wire electrode passing through said guiding tube clipped between said first transmission wheel and said second transmission wheel, and said first transmission wheel and said second transmission wheel clipping and driving said wire electrode to thread through said top wire guide.

5. The compound electrical discharge machining apparatus of claim 4, wherein said transmission module further includes a guiding base, disposed between said wheel set and said top wire guide, having a guiding channel, and said wheel set driving said wire electrode to pass through said guiding channel to said top wire guide.

6. A small-hole electrical discharge machining module, comprising:
a guiding tube, passed by and guiding a wire electrode;
a transmission module, located below said guiding tube, and transmitting said wire electrode passing through said guiding tube;
a wire guide, located below said transmission module, corresponding to said guiding tube, and said transmission module transmitting said wire electrode to thread through said wire guide; and
a power module, connecting to said wire electrode and a workpiece located below said wire guide, supplying power to said wire electrode and said workpiece for performing small-hole electrical discharge machining and forming a through hole in said workpiece.

7. The small-hole electrical discharge machining module of claim 6, and further comprising:
a reel module, reeling said wire electrode; and
a heating module, heating said wire electrode, said transmission module clipping and fixing one end of said wire electrode, and said reel module rolling and pulling said wire electrode for straightening said wire electrode.

8. The small-hole electrical discharge machining module of claim 7, wherein said heating module further comprises:
at least a heating element, contacting said wire electrode; and
a heating power module, coupled to said heating element, and supplying power to said heating device for heating said wire electrode.

9. The small-hole electrical discharge machining module of claim 6, wherein said transmission module includes a wheel set, comprising:
a first transmission wheel, driven to rotate by a driving module; and
a second transmission wheel, corresponding to said first transmission wheel, said first transmission wheel driving said second transmission wheel to rotate, said wire electrode clipped between said first transmission wheel and said second transmission wheel, and said first transmission wheel and said second transmission wheel clipping and driving said wire electrode to thread through said wire guide.

10. The small-hole electrical discharge machining module of claim 9, wherein said transmission module further includes a guiding base, disposed between said wheel set and said wire guide, having a guiding channel, and said wheel set driving said wire electrode to pass through said guiding channel to said top wire guide.
